(19) United States
(12) Patent Application Publication
(10) Pub. No.: US 2010/0175261 A1
(43) Pub. Date: Jul. 15, 2010

(54) SAFETY RAZOR

(75) Inventor: Samuel Lax, Mission Hills, CA (US)

Correspondence Address: KELLY LOWRY & KELLEY, LLP, 6320 CANOGA AVENUE, SUITE 1650, WOODLAND HILLS, CA, 91367, US

(73) Assignee: L.I.F.E. SUPPORT TECHNOLOGIES, LLC, Mission Hills, CA (US)

(21) Appl. No.: 12/728,664

(22) Filed: Mar. 22, 2010

Related U.S. Application Data
(63) Continuation-in-part of application No. 12/177,754, filed on Jul. 22, 2008.

(51) Int. Cl. B26B 21/44; B26B 21/00; B26B 21/52

(52) U.S. Cl. 30/41; 30/50; 30/526

(57) ABSTRACT

The safety razor includes a blade housing and a ceramic blade having a base disposed within the blade housing. The ceramic blade generally extends outwardly from the blade housing to expose a cutting edge suitable for shaving. The blade housing itself extends through at least a portion of the base to non-removably lock the ceramic blade therein. Accordingly, attempting to remove the ceramic blade from the blade housing results in destruction of the cutting edge.

### BACKGROUND OF THE INVENTION

The present invention relates to a disposable razor. More particularly, the invention relates to a disposable safety razor that shatters upon attempted removal from the razor head.

Hand-held articles such as toothbrushes, razors, writing instruments or utensils can be dangerous, when modified, especially in prisons or hospitals. For example, prison inmates may melt plastic toothbrushes into sharp objects for use as knives. Metal blades from shavers or razors may be extracted and attached to an elongated handle for use as a knife or other sharp weapon. Resourceful prison inmates can even modify plastic eating utensils such as knives, forks and spoons to produce weapons. Notably, prison inmates are extremely resourceful and frequently create dangerous weapons from the aforementioned everyday articles. These hand-held weapons can, in turn, be used to attack other inmates or even prison guards.

Shaving razors, in particular, can be especially dangerous because they carry cutting blades. Most shaving razors consist of three main parts: (1) a head portion made from a rigid plastic or metal body; (2) a conventional razor blade or multiple razor blades mounted in the head; and (3) a handle, typically fabricated from a robust, rigid material such as plastic. The shaving razor head and body are usually strong and only structurally fail under forces that far exceed normal everyday use. The blade mounted within the head portion is of particular concern because of the presence of an extremely sharp cutting blade. The blade in most shaving razors can be easily extracted from the head portion. For example, some blades are designed to be interchanged so a user may easily remove an old worn down blade with a new, sharp blade. Other shaving razor designs include head and body portions that are frangible, thereby enabling easy removal of the blade therefrom. In prison or hospital environments, the blade can be attached to another article and used as a weapon. This is particularly dangerous as prison inmates and potentially suicidal hospital patients may easily extract and use the corresponding blade for unintended purposes. Utilizing easily breakable body or head portions with the razor blade assembly may actually increase the number of injuries in correctional facilities or hospitals because the blades are even more easily removable.

Materially, most razor blades are formed from composite or alloy metal materials. Razor blades have also been manufactured from other types of materials, including ceramic, glass or other vitreous materials. Thus, a variety of non-metallic blade constructions are available in the prior art. But, manufacturing razors having blades other than metal require a host of fabrication steps. For instance, glass blades are especially difficult to mass produce and assemble because separately formed glass elements are difficult to fuse together. Ideally, glass is fused or formed immediately into the razor blade assembly, such as being immediately mounted to the head portion. Manufacturing a blade that requires a complex assembly process is more expensive to mass produce than other, simpler, razor blades. Unsurprisingly, simple disposable metallic-based razors dominate current market sales.

Even simple metallic razor blade assemblies have several manufacturing, processing and assembly steps. For example, assembly may require that several individual or partially assembled components be put together at one or more workstations. In this regard, generally at least the body portion, the head portion, and the blade require assembly. The head portion may include a slot for permanently or interchangeably securing one or more blades therein. The handle portion and the head portion may be formed together or separately. The two must be connected when separately formed. Some manufacturing techniques known in the art mold a thermoplastic material around opposite side edges of the blades. To protect the blades during the assembly process a selectively removable cap may also be attached to the head to protect the otherwise exposed blades.

One common manufacturing problem associated with metallic-based razors is consistent blade performance. In particular, specific spatial positioning of metallic razor blades in the head portion of the razor assembly dictates the angles at which the blades contact the skin. This directly affects shave performance. The quality of razor fabrication and subsequent assembly can affect the consistency at which the blades are assembled into the razor head. For example, shave performance is at least partially based on the placement of the blades in the head. Sometimes users undesirably experience vibrations of the blades during shaving. This is commonly referred to as “chatter”. Chatter detracts from the overall “smoothness” of the shave. Separate fabrication and assembly steps typically contribute to chatter. Mass manufacturing of razor blades has improved over the years through the use of plastic parts and injection molding. Accordingly, manufacturers are able to produce more consistently dimensioned products using these manufacturing techniques. One drawback, however, is that these plastic parts are only used for the head and body portions of the razor assembly and do not significantly improve blade performance.

Another drawback of metallic-based blades is that the razor blade itself tends to bend during shaving. The blade should ideally be flush against the shaving surface. But, flexible metallic-based blades tend to bend at the middle of the blade due to counter-active forces along the shaving surface and a lack of support therein. Consequently, matching mating parts of the razor assembly should be carefully aligned during assembly. Adequate care may require labor intensive quality assurance measures, which ultimately increase the cost of manufacturing.

Another drawback of the aforementioned razor blade assemblies includes vibrations among various subcomponents and vibrations of the actual razor blade assembly itself during shaving. Vibrations among subcomponents of the razor blade assembly are commonly referred to as “clam-shelling.” Clam-shelling may occur between loose fitting sections of the head and body portions. For example, the head may vibrate back and forth relative to the body. Another undesirable vibration is associated with the cantilever design of most convention razor blade assemblies. In this case, the user applies a force at one end of the body portion such that the head portion, containing the blades therein, contacts the shaving surface. The blades attach to and are supported at opposite edges of the head portion. The blades are generally less supported away from the edges of the head and toward the middle of the head portion. The material stiffness of the blades ultimately determines the amount the blades are able to bend. Rapid bending and returning of the blades themselves can cause vibration because the head and corresponding blades do not remain flush with the shaving surface. In this case, the cantilever configuration of the razor blade assembly allows the head and corresponding blades to undesirably hop or vibrate along the shaving surface.

Disposable shaving razors known in the art also include mechanisms for retaining shaving cream in the body portion of the razor. In one prior art device, the shaving cream manually dispenses by telescopic movement of a handle over a central stem of the razor. Accordingly, the shaving cream dispenses through an aperture in the head of the razor. A pressure sensitive adhesive coats the surface around the aperture for sealing the dispensing aperture prior to use of the razor. But, this prior art device must be sealed together in several different layers to retain and hold the shaving cream. Moreover, the telescopic handle and central stem must be rigid and could be used as a weapon by inmates, similar to a toothbrush handle.

Thus, there exists a significant need for a disposable razor that cannot be manipulated into a weapon and includes a blade that breaks with attempted removal therefrom. Such an improved razor blade assembly should include a pliable plastic handle for retaining shaving cream therein and a hard plastic housing for retaining a ceramic blade such that the ceramic blade shatters into useless fragments upon attempted removal from the housing. Moreover, the improved razor blade assembly should be easy to manufacture, assemble and be cost effective. The present invention fulfills these needs and provides further related advantages.

### SUMMARY OF THE INVENTION

The safety razor disclosed herein generally includes a blade housing and a ceramic blade having a base disposed within the blade housing. The ceramic blade generally extends outwardly from the blade housing to expose a cutting edge suitable for shaving. Preferably, the blade housing extends through at least a portion of the base to non-removably lock the ceramic blade therein. Accordingly, attempting to remove the ceramic blade from the blade housing results in destruction of the cutting edge. This occurs because the blade housing is made from a material relatively more rigid than the ceramic blade. In one embodiment, the ceramic blade may include multiple cutting edges coupled together by the base. Moreover, the blade housing may include a carriage extending away from the handle to optimize contact of the cutting edge with a shaving surface. A handle made from a pliable plastic material may also be selectively attached to the blade housing.

The blade housing may extend through at least a portion of the base in one of several different embodiments. For example, the blade housing may extend through a longitudinal aperture formed through the body of the base. The single longitudinal aperture may, in an alternative embodiment, be replaced by multiple longitudinal apertures formed through the body of the base. In another embodiment, the blade housing extends through a notch formed along at least one side of the base. More preferably, the blade housing extends through a pair of notches formed on opposite sides of the base. In these embodiments, the blade housing restricts horizontal and vertical movement of the ceramic blade therein by virtue of extending through at least a portion of the base. This feature enhances the non-removability of the ceramic blade and base within the interior of the blade housing. In another alternative embodiment, the blade housing may extend through both a notch and an aperture formed in the base, and may encompass at least a portion of the base to securely lock the ceramic blade within the blade housing.

Other features and advantages of the present invention will become apparent from the following more detailed description, when taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a perspective view of a disposable razor, in accordance with the present disclosure;

FIG. 2 is a side view of the disposable razor of FIG. 1;

FIG. 3 is a front view of the disposable razor of FIG. 1;

FIG. 4 is a perspective environmental view of the disposable razor, illustrating dispensing shaving cream after removal of a nib;

FIG. 5 is an environmental view illustrating shattering a ceramic razor blade upon attempted removal from a rigid plastic housing;

FIG. 6 is a cross-sectional view of the disposable razor, taken about the line 6-6 of FIG. 1;

FIG. 7 is a cross-sectional view of the disposable razor, taken about the line 7-7 of FIG. 4, illustrating dispensing shaving cream after nib removal;

FIG. 8 is an enlarged partial cross-sectional view of a pair of ceramic razor blades mounted in the plastic housing, taken about the circle 8 of FIG. 6;

FIG. 9 is an enlarged cross-sectional view of the plastic housing, illustrating shattering of the ceramic razor blades therein;

FIG. 10 is a perspective view illustrating a dual blade mounted within a partial cutaway of the razor head;

FIG. 11 is a perspective view similar to FIG. 10, illustrating a dual blade having an elongated aperture in the blade base;

FIG. 12 is a perspective view similar to FIG. 10, illustrating a dual blade having a plurality of elongated apertures in the blade base;

FIG. 13 is a perspective view similar to FIG. 10, illustrating a dual blade having a notch formed along one side of the base;

FIG. 14 is a perspective view similar to FIG. 10, illustrating a dual blade having a combination of the notch and the elongated aperture;

FIG. 15 is a perspective view similar to FIG. 10, illustrating a dual blade having a combination of the notch and a plurality of the elongated apertures;

FIG. 16 is a perspective view illustrating a single blade mounted within a partial cut away of the razor head;

FIG. 17 is a perspective view similar to FIG. 16, illustrating a single blade having an elongated aperture in the blade base;

FIG. 18 is a perspective view similar to FIG. 16, illustrating a single blade having a plurality of elongated apertures in the blade base;

FIG. 19 is a perspective view similar to FIG. 16, illustrating a single blade having a notch formed along one side of the base;

FIG. 20 is a perspective view similar to FIG. 16, illustrating a single blade having a combination of the notch and the elongated aperture; and

FIG. 21 is a perspective view similar to FIG. 16, illustrating a single blade having a combination of the notch and a plurality of the elongated apertures.

### DETAILED DESCRIPTION OF THE PREFERRED EMBODIMENTS

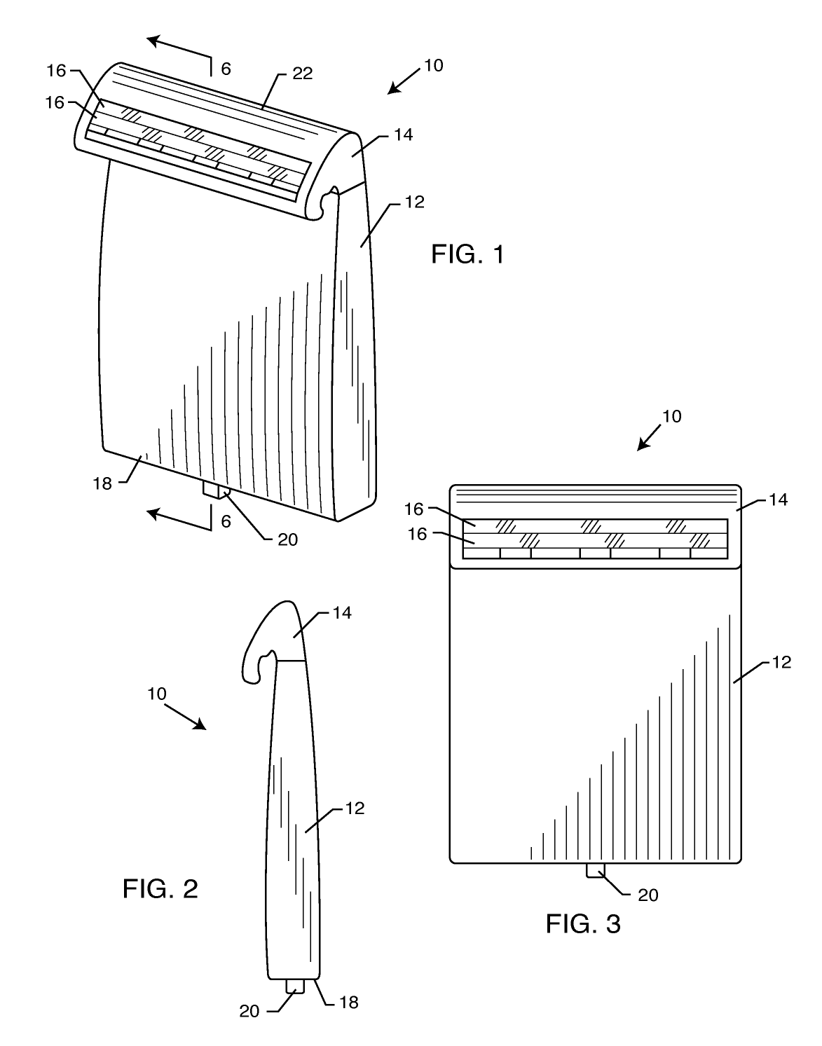

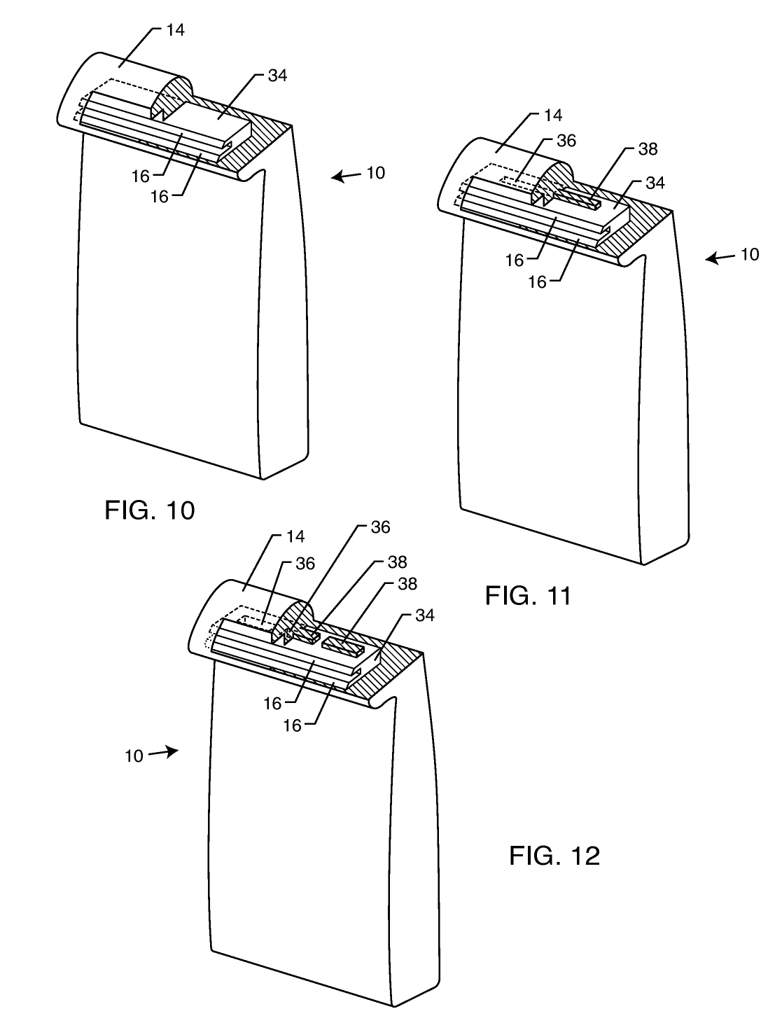

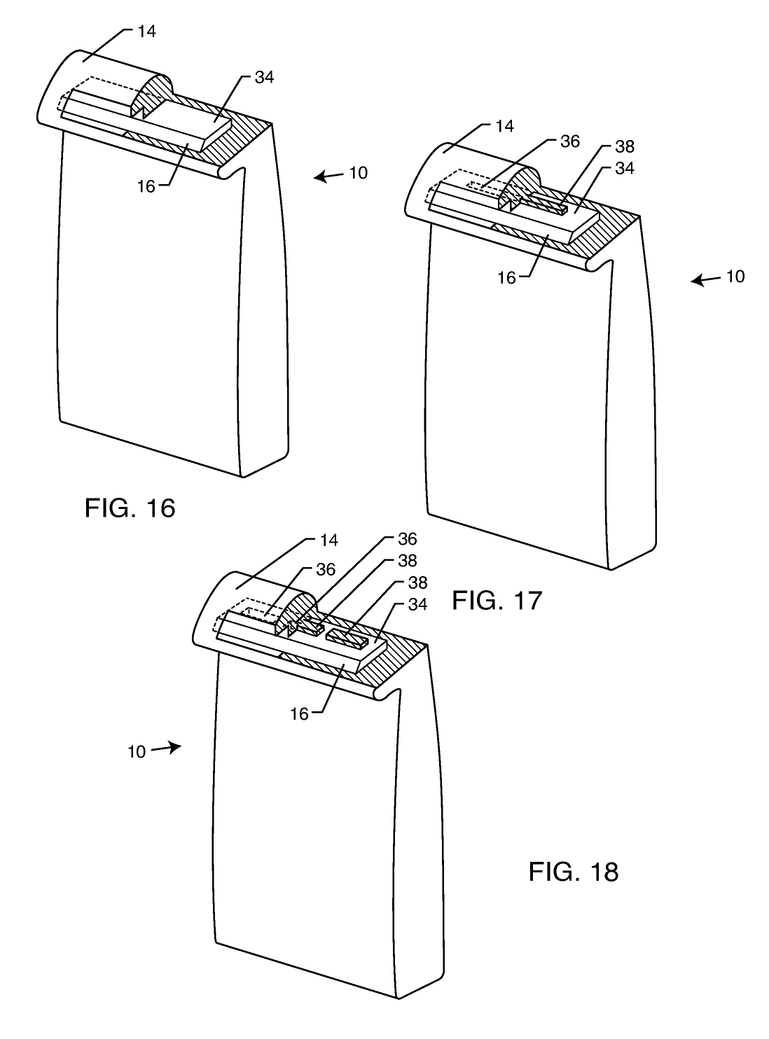

As shown in the drawings for purposes of illustration, the present invention for a disposable razor is referred to generally by the reference number 10. In FIG. 1, the disposable razor 10 generally includes a body 12 and a head 14 for retaining a ceramic blade 16 (FIGS. 16-21) or a plurality of ceramic blades 16 (FIGS. 10-15). The disposable razor 10 is ideal for gift packs for hotels, motels, hospitals, airlines and for other company or product advertisements, or give-away toiletry items. For example, a logo or other advertisement may be applied to the body 12. The disposable razor 10 is also particularly ideal for use in prisons and hospitals as the ceramic blade 16 shatters upon attempted removal from the head 14, as described in more detail below. That is, inmates and suicidal hospital patients would no longer be able to extract the ceramic blade 16 from the head 14 for use as a weapon or to impose self-inflicted wounds. Hence, the disposable razor 10 could save thousands of dollars in medical expenses from injuries related to blades that could previously be extracted from the head 14 and used as a weapon.

The overall size of the disposable razor 10 is preferably close to that of a common book of matches. In a particularly preferred embodiment, the disposable razor 10 is one and thirteen-sixteenth inches long, one and one-half inches wide and one-fourth inches thick at a bottom end 18 having a breakaway nib 20. Moreover, the disposable razor 10 is preferably approximately one-fourth to five-sixteenths inches thick at a top end 22 where the ceramic blade 16 is affixed to the head 14. Thus, the overall size of the disposable razor 10 is ideal for traveling or for use in small areas, such as a hotel room or prison bathroom. The disposable razor 10 may also be grouped with other toiletry items provided to hotel guests, provided in a gift pack or sold in a travel pack.

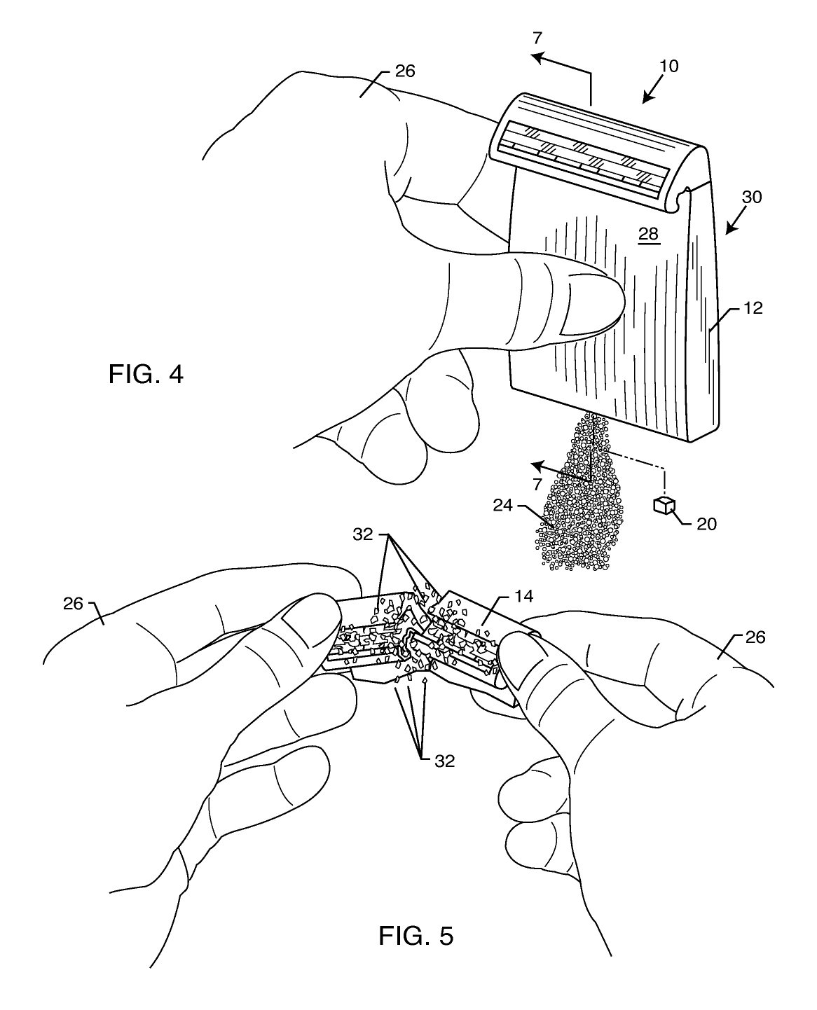

As shown in FIG. 2, the body 12 generally angles outwardly from the head 14 toward the bottom end 18. The body 12 is preferably manufactured from a pliable plastic material that can be deformed by being squeezed. The body 12 should be flexible enough such that a shaving solution 24 may be dispensed therefrom after the nib 20 breaks away from the body 12 (FIG. 4). FIG. 4 specifically illustrates a user hand 26 grasping a front portion 28 and a rear portion 30 of the body 12 to dispense the shaving solution 24 therefrom.

FIG. 3 illustrates a front view of the disposable razor 10. In this embodiment, the head 14 includes a pair of ceramic blades 16 mounted therein. The head 14 is preferably manufactured from a hard plastic material that encases at least the external ends of the ceramic blades 16. Preferably, the head 14 is manufactured using an injection molding machine capable of casting (injecting) twenty-four units at a time. This is accomplished by first mounting one or more of the ceramic blades 16 in an injection molding die. Thereafter, hot injection molding material is rapidly injected into the die and molded around the ceramic blades 16 to form the head 14 generally shown in FIG. 3. The head 14 cools into a hardened plastic material substantially resilient to bending or flexing. Of course, the injection molding die would be designed to retain standard size razors (i.e. the ceramic blades 16) as most single edge, double edge and injection molding blades are the same width—i.e. the width of a standard book of matches. Moreover, the head 14 is curved (see FIG. 2) similar to that of a bent book of matches. This angle is the preferred shaving angle for use with the disposable razor 10 because it enhances shave quality. The head 14 may be manufactured from a hard plastic material similar to that used with conventional metallic-based razors.

FIG. 3 also illustrates the wide body configuration of the body 12. The body 12 is different from conventional razors known in the art because the width of the body 12 extends approximately the width of the head 14 and the ceramic blades 16. Conventional razors have long and skinny handles. The head portion of conventional razors is therefore more difficult to control and maneuver during shaving due to torque about the elongated handle. Such torque is nearly nonexistent in the present disposable razor 10. The wide base of the body 12 provides this enhanced control during shaving. The surface area of the body 12 is also larger and easier to grasp. These features also allow users to stabilize movement of the disposable razor 10 during shaving to prevent other undesirable vibrations.

The ceramic blade 16 mounts to the head 14, which is manufactured from a hard plastic material as described above. The interplay between the ceramic blade 16 and the plastic head 14 makes it impossible to extract the ceramic blade 16 therefrom without completely shattering or destroying the ceramic blade 16. FIG. 5 illustrates a user having removed the head 14 from the body 12. In FIG. 5, a pair of hands 26 bend the head 14 near its longitudinal mid point. The force required to break the plastic material of the head 14 is much greater than any force used during shaving. The ceramic blade 16 is otherwise locked within the plastic material comprising the head 14 during the molding process. But, attempting to remove the ceramic blade 16 as shown in FIG. 5 causes, not only the head 14 to snap into pieces, but also causes the ceramic blade 16 to shatter into a plurality of pieces 32. In fact, simply twisting or even bending the head 14, without breaking it, causes the ceramic blade 16 to shatter. The ceramic blade 16 shatters into the plurality of pieces 32 primarily because it has brittle ceramic material properties. This aspect of the disposable razor 10 effectively prevents a prison inmate or a mental health facility patient from bending or breaking the head 14 and extracting the ceramic blade 16 therefrom. Accordingly, the pieces 32 are completely useless fragments of the original ceramic blade 16. The pieces 32 cannot be used as a weapon as could conventional metallic-based razors extracted from a head portion thereof.

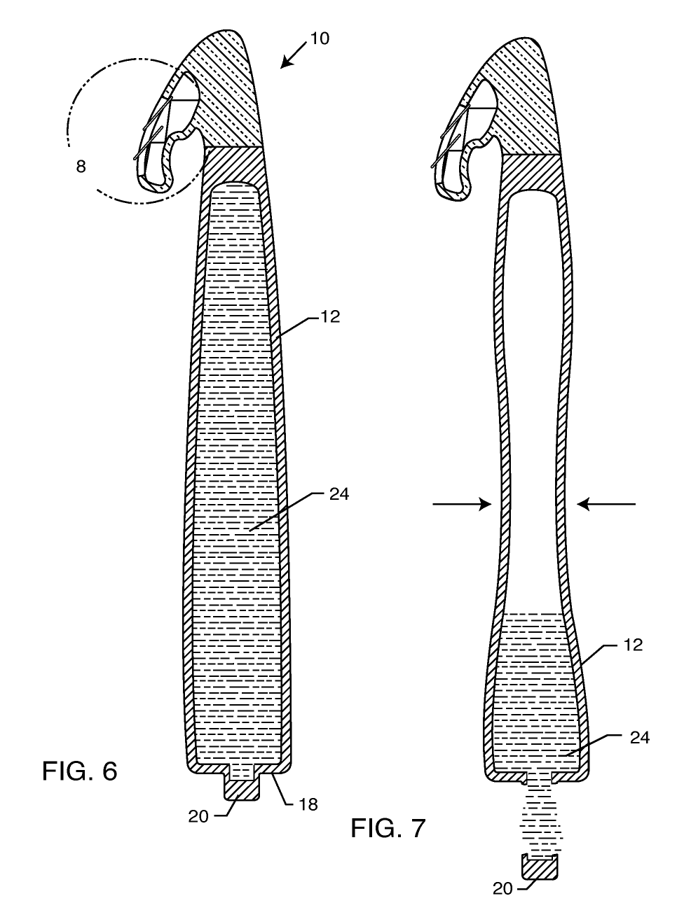

FIG. 6 illustrates a cross-sectional view of the disposable razor 10 having the shaving solution 24 within the body 12. As shown, the nib 20 extends from the bottom end 18 of the body 12 to be selectively removed therefrom when the contents (i.e. the shaving solution 24) is to be dispensed. In application, a user breaks the nib 20 away from the body 12 (FIG. 7). The body 12 is then compressed along the directional arrows generally shown in FIG. 7 to dispense the shaving solution 24 out from within the interior of the body 12. The pliable plastic material that comprises the body 12 compresses as shown between FIGS. 6 and 7. The shaving solution 24 may include any type of liquid, including shaving gel, aftershave, shaving cream, shaving oil, lotion or soap. Appropriately, the nib 20 may be broken away from the body 12 either before shaving, in the case of shaving gel, or after a shave, in the case of aftershave. The nib 20 may, alternatively, be a cap or other removable device capable of retaining the shaving solution 24. One important aspect of the body 12 is that the body 12 cannot be readily made into an elongated and substantially hardened weapon as can be done with conventional razor blade handles. As such, the pliable plastic material that comprises the body 12 is preferably soft and flexible. The body 12 does not include any elongated sections of rigid plastic that could be removed from the head 14 and melted or sharpened at one end into a weapon.

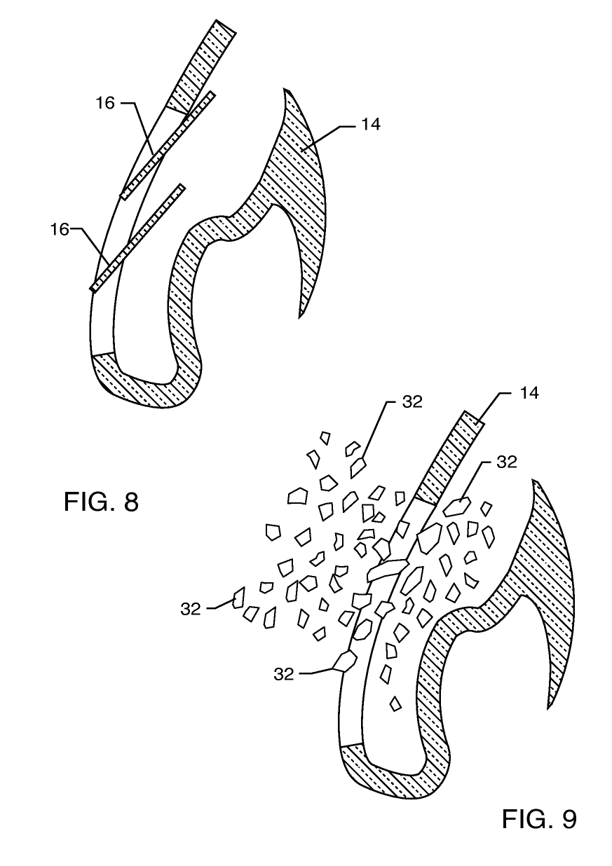

FIGS. 8 and 9 illustrate a pair of ceramic blades 16 mounted to the head 14. As shown in FIG. 8, the ceramic blades 16 mount within the head 14 at an angle to enhance the comfort of the shave. The ceramic blades 16 are approximately twice as hard as stainless steel and can withstand extremely high temperatures. But, the ceramic blades 16 cannot withstand minor deformation (e.g. twisting). The inherent brittleness of ceramic material causes the ceramic blades 16 to break into the pieces 32 (FIG. 9) when the head 14 is twisted, distorted or otherwise broken in half (FIG. 5). In this instance, ceramic is a particularly ideal material for use as a razor blade. Ceramic has desirable properties of high strength, hardness and corrosion resistance and can be manufactured to provide a satisfactory sharp shaving edge. Moreover, ceramic blades offer precise blade extension with cleaner, sharper cutting edges than conventional metal-based razor blades. Ceramic is also resistant to bending, unlike metallic-based blades. Thus, the entire length of a ceramic blade is engageable with the shaving surface, which is an improvement over metallic-based blades that tend to bend or bow in unsupported areas of the razor blade assembly. Accordingly, the ceramic blade 16 is better supported and more resistant to bending, which helps prevent and eliminate the aforementioned and undesirable vibrational characteristics associated with metallic-based razor blades. Moreover, over time, steel materials often exhibit increased strength in the work area (e.g. the sharpened edge) from extensive use. Ceramic material subjected to similar operation does not exhibit similar material strengthening in the work area because ceramic is considerably more brittle and does not bend under similar loads. Thus, ceramics are much more susceptible, relative to metal-based razor blade edges, to fracture-type breakage. This is particularly ideal in the present disclosure as the ceramic blades 16 are well suited for limited or one-time use in a prison or mental facility where inmates or patients of these institutions are unable to remove the ceramic blade 16 from the head 14 absent shattering the ceramic blade 16 into a plurality of pieces 32 (FIG. 9). Hence, the ceramic blade 16 cannot be removed and used to injure others or to inflict wounds, such as in an attempted suicide. Rather, ceramic blades 16 shatter into the useless pieces 32 upon attempted removal from the head 14.

The ceramic blade 16 may be manufactured from any one of a plurality of polycrystalline ceramic substrate materials. Such materials may include silicon carbide, silicon nitride, mullite, hafnia, yttria, zirconia or alumina. Alternatively, the ceramic blades 16 could comprise polycrystalline ceramic substrate materials being adhered in alumina and hot isostatically-pressed tetragonal zirconia. The abraded edge of the ceramic blade 16 may then be subjected to heat-treatment, referred to as “annealing”. Annealing reduces surface raggedness and substrate defects resulting from initial mechanical abrasion manufacturing. Once complete, the ceramic blade 16 remains brittle relative to the head 14 and shatters upon attempted removal once molded to the head 14.

FIGS. 10-15 illustrate various embodiments of the ceramic blade 16 compatible with the disposable razor 10 disclosed herein. For example, FIG. 10 illustrates a partial cutout of the head 14 to illustrate the positioning of the ceramic blades 16 within the interior of the head 14. Each of the blades 16 are commonly linked to one another via a base 34 disposed substantially within the interior of the head 14. In the embodiment shown in FIG. 10, the head 14 simply extends around and encompasses the entire exterior periphery of the base 34 and encompasses a portion of the ends of the ceramic blades 16 (as shown in phantom). The portion of the head 14 that extends over a portion of the ceramic blades 16 prevents a user from simply pulling the ceramic blades 16 and the corresponding base 34 out from within the head 14. As discussed in greater detail below, the base 34 includes a variety of mechanisms to enhance locking placement within the head 14 to prevent, among others, horizontal and vertical movement.

For example, FIG. 11 illustrates an embodiment wherein the base 34 includes a single longitudinal aperture 36 extending through a portion of the base 34. The longitudinal aperture 36 is filled by the head 14 as best shown by a block 38 extending out from the longitudinal aperture 36 and the base 34 in the cutaway view of the head 14. Extrusion of the block 38 through the longitudinal aperture 36 further lockingly retains the ceramic blades 16 of the base 34 within the head 14. The block 38 effectively prevents horizontal or vertical movement of the base 34 or the ceramic blades 16. A user would be required to break a portion of the head 14 away from the base 34 to slide the block 38 out from within the longitudinal aperture 36. This is extremely difficult because the head 14 is now formed, not only around the exterior surface of the base 34 and a portion of the ceramic blades 16, but through the longitudinal aperture 36 formed within the interior of the base 34. This only further enhances the retention and rigidity of the ceramic blades 16 and the base 34 within the interior of the head 14. Accordingly, this design cuts down on any undesired vibrational movement of the ceramic blades 16 and increases the difficulty in dislodging the ceramic blades 16 from the head 14 without shattering the ceramic blades 16 as described above. In fact, the relative material properties of the head 14 relative to the ceramic blades 16 and the base 34 make it impossible to remove the ceramic blade 16 from the head 14. That is, deforming any portion of the head 14 that may cause it to break will cause the ceramic blades 16 to shatter.

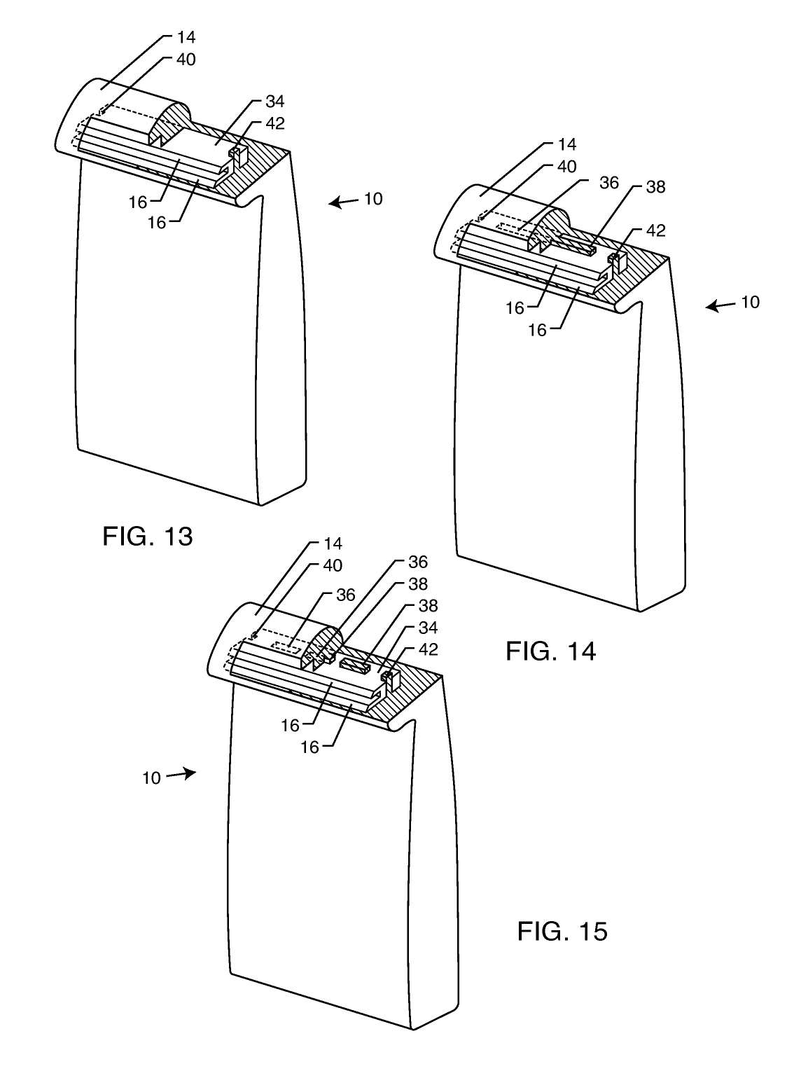

FIG. 12 illustrates an alternative embodiment to the single longitudinal aperture 36 described above with respect to FIG. 11. FIG. 12 illustrates multiple of the longitudinal apertures 36 and multiple blocks 38 extending through those longitudinal apertures 36. The cutout view of FIG. 12 best illustrates how the blocks 38 extend through the longitudinal apertures 36 and are formed as part of the head 14 to effectively lock the base 34 and the ceramic blades 16 to the head 14. FIG. 13 is another alternative construction wherein the longitudinal aperture 36 is replaced by a pair of notches 40 at opposite ends of the base 34. A notch block 42 accordingly extends through the notches 40 and provides a similar locking mechanism as the block 38 that extends through the longitudinal apertures 36, as described above. One or more of the notches 40 and the notch blocks 42 may be used in the construction shown in FIG. 13. Preferably, the notches 40 are formed at opposite ends of the longitudinal base 34 to prohibit horizontal and vertical movement of the base 34 within the interior of the head 14. Accordingly, the notches 40 are effective at preventing side-to-side and forward-to-back movement of the base 34 within the head 14. Again, removal of the ceramic blades 16 and the base 34 would require breaking a portion of the head 14 to free movement of the base 34 from the notch blocks 42. In doing so, a user would effectively shatter the ceramic blades 16 and the base 34 into useless fragments because of the relative brittleness of the ceramic blades 16 relative to the head 14.

FIGS. 14 and 15 illustrate a combination of the longitudinal aperture 36 and the notches 40 within the base 34. For instance, FIG. 14 illustrates the single longitudinal aperture 36 having the block 38 extending therethrough. Furthermore, the base 34 includes a pair of the notches 40 formed at opposite ends thereof and having the notch blocks 42 extend therethrough. The features of the block 38 and the notch blocks 42 extending through the respective longitudinal aperture 36 and the notches 40 prevents side-to-side and forward-to-back movement of the base 34 within the interior of the head 14. In a similar embodiment, FIG. 15 merely replaces the longitudinal aperture 36 with multiple longitudinal apertures 36 and the singular block 38 with multiple blocks 38 extending through those multiple longitudinal apertures 36. In these embodiments, the head 14 extends through more portions of the base 34 and decreases the amount of ceramic material between each of the longitudinal apertures 36 and notches 40. In doing so, the base 34 and the ceramic blades 16 are more prone to shattering in the event any portion of the head 14 is broken.

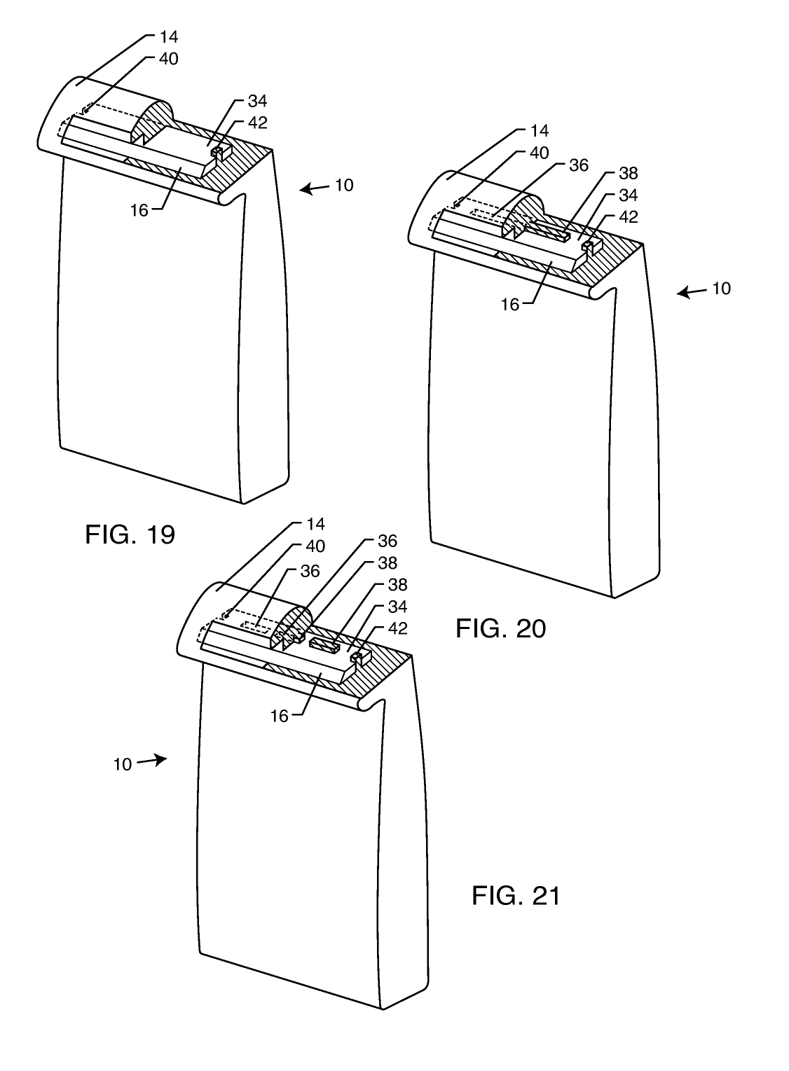

The embodiments illustrated with respect to FIGS. 16-20 are similar in concept to those embodiments disclosed with respect to FIGS. 10-15, except that the pair of ceramic blades 16 illustrated in FIGS. 10-15 are replaced with a singular ceramic blade 16. Specifically, FIG. 16 illustrates the single ceramic blade 16 disposed within the interior of the head 14. As shown, a portion of the head 14 encompasses the outer ends of the ceramic blade 16. The ceramic blade 16 is also held in place by the head 14, which encompasses the outer surface periphery of the base 34. FIG. 17 illustrates the single longitudinal aperture 36 having the block 38 extending through the base 34. This locks the ceramic blade 16 to the head 14 in a manner similar to that described with respect to FIG. 11 above. FIG. 18 similarly locks the ceramic blade 16 to the head 14 through implementation of the multiple longitudinal apertures 36 and the multiple blocks 38. Like FIG. 13, FIG. 19 makes use of the notches 40 and the notch blocks 42 within the base 34 to secure the ceramic blade 16 to the head 14. FIGS. 20 and 21 utilize the combination of the longitudinal aperture 36 and the block 38 with the notches 40 and the notch blocks 42 in the base 34 to lock the ceramic blade 16 to the head 14 in a manner comparable to FIGS. 14 and 15—except with respect to the single ceramic blade 16 instead of the dual ceramic blades 16.

In general, the purpose of adding the longitudinal aperture 36 (or multiple longitudinal apertures 36) and the notches 40, or a combination thereof, is to ensure the highest degree of locking the ceramic blade 16 to the head 14 via the base 34. The additional features of the longitudinal apertures 36 and the notches 40 having the corresponding blocks 38 and the notch blocks 42 extending therethrough further prohibits side-to-side movement, forward-to-back movement, horizontal displacement and vertical displacement of the ceramic blade 16 within the head 14. The head 14 further substantially encompasses the bottom portion and top portion of the base 34 to mitigate any vertical movement of the ceramic blade 16 or the base 34 within the interior of the head 14. Furthermore, the longitudinal apertures 36 and the notches 40 may enable the construction of a disposable razor 10 wherein the head 14 does not need to encompass a portion of the outer periphery of the ceramic blades 16. This is because it is important that the ceramic blades 16 substantially lock to the head 14 to ensure non-removability therefrom. Without some obstruction of preventing forward-to-back horizontal movement of the ceramic blades 16, as is accomplished through use of the block 38, the notch block 42 or encompassing a portion of the outer periphery of the ceramic blade 16, a user would otherwise be able to dislodge the ceramic blade 16 from within the interior of the head 14 and merely pull out the ceramic blade 16 for use as a weapon. One or a combination of the longitudinal apertures 36, the notches 40 or the structure of the head 14 that extends over a portion of the ceramic blade 16 may be used in accordance with the disposable razor 10 disclosed herein to accomplish providing a disposable razor 10 that has a non-removable ceramic blade 16 that otherwise shatters upon attempted removal.

Although several embodiments have been described in detail for purposes of illustration, various modifications may be made to each without departing from the scope and spirit of the invention. Accordingly, the invention is not to be limited, except as by the appended claims.

What is claimed is:

1. A safety razor, comprising:
a blade housing; and
a ceramic blade having a base disposed within the blade housing, the ceramic blade extending outwardly from the blade housing to expose a cutting edge suitable for shaving;
wherein the blade housing extends through at least a portion of the base to non-removably lock the ceramic blade therein, whereby attempting to remove the ceramic blade from the blade housing results in destruction of the cutting edge.

2. The safety razor of claim 1, wherein the blade housing extends through a longitudinal aperture formed through the body of the base.

3. The safety razor of claim 2, wherein the longitudinal aperture comprises multiple apertures.

4. The safety razor of claim 1, wherein the blade housing extends through a notch formed along one side of the base.

5. The safety razor of claim 4, wherein the blade housing extends through a pair of notches formed on opposite sides of the base.

6. The safety razor of claim 1, wherein the blade housing restricts horizontal and vertical movement of the ceramic blade.

7. The safety razor of claim 1, wherein the blade housing extends through a notch and an aperture formed in the base.

8. The safety razor of claim 1, wherein the blade housing encompasses at least a portion of the base.

9. The safety razor of claim 1, wherein the blade housing comprises a material relatively more rigid than the ceramic blade.

10. The safety razor of claim 1, including a handle selectively attachable to the blade housing.

11. The safety razor of claim 10, wherein the blade housing comprises a carriage extending away from the handle to optimize contact of the cutting edge with a shaving surface.

12. The safety razor of claim 10, wherein the handle comprises a pliable plastic material.

13. The safety razor of claim 1, wherein the ceramic blade includes multiple cutting edges coupled together by the base.

14. A safety razor, comprising:
a blade housing; and
a ceramic blade having a base disposed within the blade housing, the ceramic blade extending outwardly from the blade housing to expose a cutting edge suitable for shaving;
wherein the blade housing encompasses at least a portion of the base and extends through a longitudinal aperture formed through the body of the base to restrict horizontal and vertical movement and non-removably lock the ceramic blade therein, whereby attempting to remove the ceramic blade from the blade housing results in destruction of the cutting edge.

15. The safety razor of claim 14, wherein the blade housing extends through a pair of notches formed on opposite sides of the base and the longitudinal aperture comprises multiple apertures.

16. The safety razor of claim 14, wherein the ceramic blade includes multiple cutting edges coupled together by the base and the blade housing comprises a material relatively more rigid than the ceramic blade.

17. The safety razor of claim 14, including a handle comprising a pliable plastic material selectively attachable to the blade housing, wherein the blade housing comprises a carriage extending away from the handle to optimize contact of the cutting edge with a shaving surface.

18. A safety razor, comprising:
a blade housing; and
a ceramic blade having a base disposed within the blade housing, the ceramic blade extending outwardly from the blade housing to expose a cutting edge suitable for shaving, wherein the blade housing comprises a material relatively more rigid than the ceramic blade;
wherein the blade housing encompasses at least a portion of the base and extends through a notch formed along one side of the base to horizontally and vertically non-removably lock the ceramic blade therein, whereby attempting to remove the ceramic blade from the blade housing results in destruction of the cutting edge.

19. The safety razor of claim 1, wherein the blade housing extends through multiple longitudinal apertures formed through the body of the base and a pair of notches formed on opposite sides of the base.

20. The safety razor of claim 1, including a handle comprising a pliable plastic material selectively attachable to the blade housing, wherein the blade housing is formed into a carriage extending away from the handle to optimize contact of multiple cutting edges coupled together therein by the base.
